(19) United States
(12) Patent Application Publication
(10) Pub. No.: US 2008/0250131 A1
(43) Pub. Date: Oct. 9, 2008

(54) SERVER AND RELATED METHOD FOR INSERTING DATA INTO STREAMING DATA FOR A NETWORK SYSTEM

(76) Inventor: Ching-Kang Lee, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/036,290

(22) Filed: Feb. 24, 2008

Related U.S. Application Data
(60) Provisional application No. 60/909,946, filed on Apr. 4, 2007.

(51) Int. Cl. G06F 15/173

(52) U.S. Cl. 709/223

(57) ABSTRACT

A server of a network system for inserting data into a streaming data displayed by a user comprises a first store unit, a statistic unit, a selecting unit, a displaying control unit and an output unit. The first store unit is sued for storing a plurality of data contents. The statistic unit is coupled to the first store unit and used for collecting and analyzing information of the plurality of data contents and information of the user to generate a statistic result. The selecting unit is used for selecting at least one data content from the plurality of data contents according to the statistic result. The displaying control unit is used for generating a control information for controlling the timing of displaying the selected data contents over the user. The output unit is used for transmitting the control information and the selected data contents to the user.

### CROSS REFERENCE TO RELATED APPLICATIONS

This application claims the benefit of U.S. Provisional Application No. 60/909,946, filed on Apr. 04, 2007 and entitled“System and Related Method for Inserting Data into Streaming Data”, the contents of which are incorporated herein by reference.

### BACKGROUND OF THE INVENTION

1. Field of the Invention

The present invention relates to a server and related method for inserting data, and more particularly, to a server and related method for inserting data into streaming data for a network system.

2. Description of the Prior Art

In recent years, sharing on-line becomes more and more popular. A user can watch video clips or listen music on a website, which is installed by a web server allowing the user uploading video or audio data contents to share with other users. Thus this kind of web server, such as YouTube, needs a large amount of space to store the sharing contents. When a streaming data is displayed, the displayed streaming data is downloaded from single source, namely the web server. Alternatively, the user also can utilize specific software to directly display video or audio streaming data via Peer-to-Peer (P2P) network, which is well known as a multi-node file sharing network. Any users having the same data content can simultaneously share to each other. When a user displays a video or audio program, the displayed streaming data is a combination of streaming provided by multiple users. In addition, the P2P network is commonly built up with an index server collecting indices of all streaming data of the participant users. This kind of index server only needs to store the indices instead of storing whole data contents. Thus, the user can browse whole program information on the index server.

The abovementioned servers for the content sharing service are usually combined with business applications, such as advertisement applications. When any of the servers sends advertising or system information to the user during display of the streaming data, the server has to control the user's facilities (i.e. a computer or a mobile phone) to execute software, different from the software displaying the streaming data, for processing the received information. For example, in addition to the PSP software, the user's computer is forced to open a browser window to display system information or advertisement. This is inconvenient and occupying system resource for both the server and the users. Furthermore, if the information or advertisement sent by the server is in streaming data format, the server owning the source streaming files create a new streaming data by combining the streaming data with the information or advertisement. Mostly, the information or advertisement is directly added to the beginning of the streaming data.

Thus, in the prior art, the streaming data needs to be re-edited and thereby can be downloaded for business purposes. This wastes the server too much time and cost.

### SUMMARY OF THE INVENTION

Therefore, the present invention provides a server and related method for a network system to allow the user to display two data sources, one streaming data, without recreation of a new streaming data.

The present invention discloses a server for inserting data into a streaming data displayed by a user for a communications network. The server comprises a first store unit, a statistic unit, a selecting unit, a displaying control unit and an output unit. The first store unit is sued for storing a plurality of data contents. The statistic unit is coupled to the first store unit and used for collecting and analyzing information of the plurality of data contents and information of the user to generate a statistic result. The selecting unit is used for selecting at least one data content from the plurality of data contents according to the statistic result. The displaying control unit is used for generating a control information for controlling the timing of displaying the selected data contents over the user. The output unit is used for transmitting the control information and the selected data contents to the user.

The present invention further discloses a method of inserting data into a streaming data displayed by a user coupled to a server via a communications network. The server comprises a plurality of data contents. The method comprises the following steps: collecting and analyzing information of the plurality of data contents and information of the user to generate a statistic result; selecting at least one data content from the plurality of data contents according to the statistic result; generating a control information for controlling the timing of displaying the selected data contents over the user; transmitting the control information and the plurality of data contents to the user; and displaying the streaming data and the selected data contents according to the control information by the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a framework according to an embodiment of the present invention.

FIG. 2 is a schematic diagram of the advertise server according to FIG. 1.

FIG. 3 is a schematic diagram of a user according to FIG. 1.

FIG. 4 is a flowchart of a process 40 for inserting data into streaming data according to an embodiment of the present invention.

### DETAILED DESCRIPTION

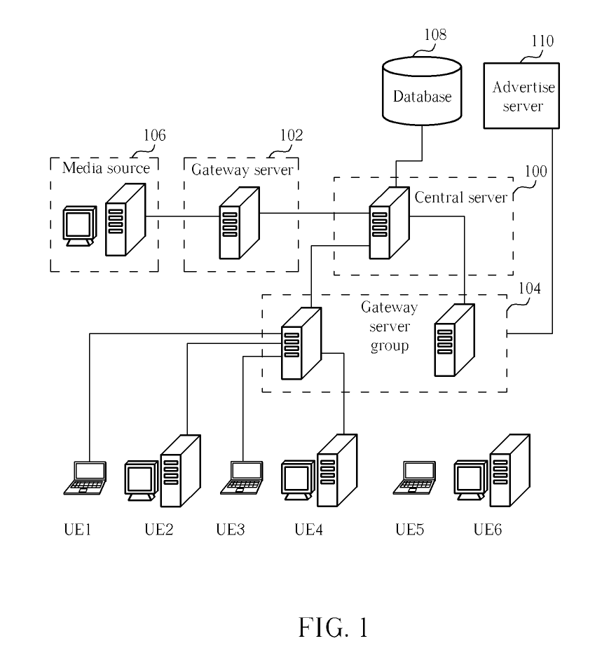

Please refer to FIG. 1, which is a schematic diagram of a framework 10 according to an embodiment of the present invention. The framework 10 is built up on a peer-to-peer network and includes a central server 100, a gateway server 102, a gateway server group 104, a media source 106, a database 108, an advertise server 110 and users UE1-UE6. The central server 100 provides multiple streaming channels for the users UE1-UE6 and records information of currently displayed streaming channels, such as channel names and program lengths, in the database 108.

The gateway server group 104 includes multiple groups of gateway servers responsible for a group of the users UE1-UE4 and the other group of the users UE5 and UE6. The gateway server 102 and the gateway server group 104 process the network information (i.e. request information and a request number corresponding to the advertisement) for the media source 106 and the users UE1-UE6, respectively. For example, the gateway server group 104 can record all channel information requested by the users UE1-UE6 and provides the advertise sever 110 with the information for statistics. Beside, the gateway server group 104 notifies the central server 100 of the request for the channel list and transfers the channel list to the user.

The media source 106 provides video or audio programs for publishing on the network and exchanges program information with the central server 100 via the gateway server 102. The users UE1-UE6 can be a personal computer or a notebook and includes display units DU1-DU6, respectively. Each user can connect to the gateway server group 104 and receive the channel list from the central server 100. The advertise server 110 includes various advertisements and customizes advertising content for the users UE1-UE6 according to users' interests, occupations or types of frequently selected programs. The advertisements could be text, image or media content and can be transmitted in a streaming or other file transferring way. In addition, the advertise server 110 also sends control information to the user for controlling the timing of displaying the advertisements.

When a user browses the channel list provided by the central server 100 and selects a channel to display, the user searches the media content from the nearest sources and also becomes a participant of the P2P network. The display unit of the user then downloads and also displays the corresponding streaming data from other users and/or the media source 106, depended on the limitation of a maximum connection number. Meanwhile, the advertise server 110 examines the user preference and thereby customizes for the user with the advertising packets including advertisements and the control information. The users directly downloads the advertising packets from the advertise server 110. The control information can control the user to display the advertisements in the following situations: (1) during waiting for download requests; (2) periodically during the streaming display; (3) beforehand the streaming display or afterward the complete streaming display. At the time point of displaying the advertisement in the second situation, the users temporarily stops displaying streaming and then imports the advertisement to the display unit. After the advertisement is accomplished, the display resumes the streaming display. During the advertisement display, downloading the streaming data is continued and not affected by the temporary stop.

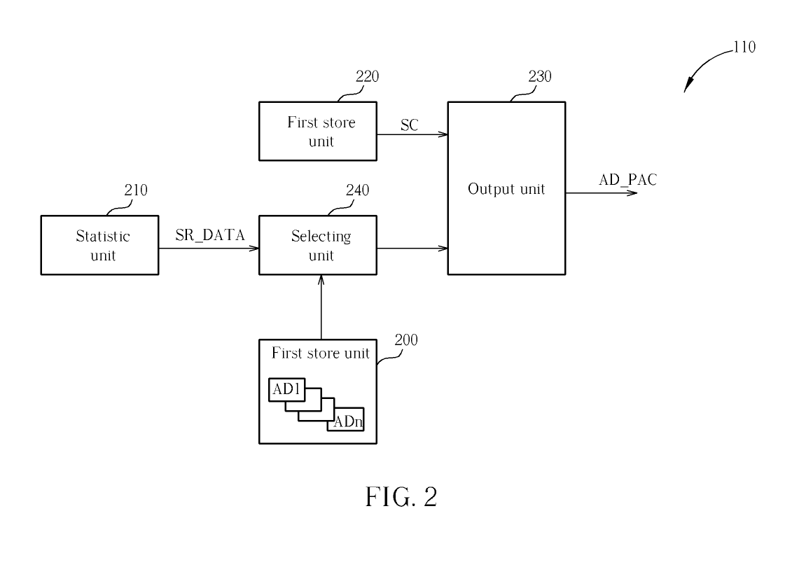

Please refer to FIG. 2, which is a schematic diagram of the advertise server 110 according to an embodiment of the present invention. The advertise server 110 includes a first store unit 200, a statistic unit 210, a displaying control unit 220, an output unit 230 and a selecting unit 240. The first store unit 200 is used for storing a plurality of data contents, namely advertisements AD1-ADn provided by contractors, store members or companies. The statistic unit 210 is used for collecting and analyzing information of the advertisements and information of the user to generate a statistic result SR_DATA. The selecting unit 240 is used for selecting at least one advertisement from the advertisements AD1-ADn according to the statistic result SR_DATA. The displaying control unit 220 is used for generating a control information SC for controlling the timing of displaying the selected advertisements over the user. The control information SC can control the user to display the selected advertisements at the time points before, during or after the display of the streaming data. The selected advertisements and the control information are combined into the abovementioned advertising packets AD_PAC. The output unit 230 is used for transmitting the advertising packets AD_PAC to any of the users UE1-UE6 that make a request for channels. The statistic unit 210, the selecting unit and the displaying control unit 220 cooperate to achieve customization.

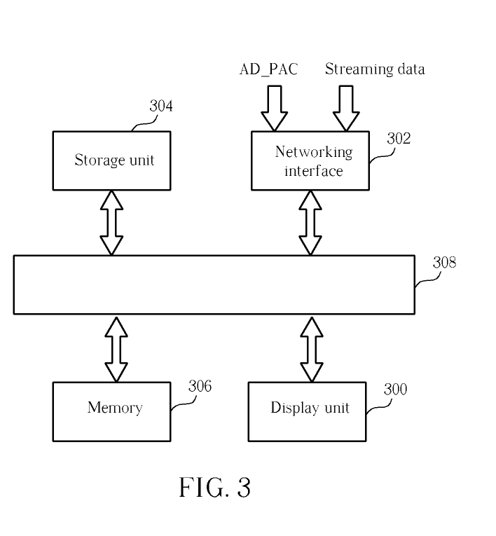

Please refer to FIG. 3, which is a schematic diagram of a user 30 according to an embodiment of the present invention. The user 30 is applied to a P2P network with the advertise server 110 and includes a display unit 300, a networking interface 302, a storage unit 304, a memory 306 and a bus 308 responsible for the data transfer among the display unit 300, the networking interface 302, the storage unit 304 and the memory 306. The networking interface 302 is compatible with P2P and point-to-point data transfer, and receives the advertisement packet AD_PA from the advertise server 110 and the streaming data from other users or/and media source 106. The memory 306 temporarily stores the streaming data. The storage unit 304 is preferably a hard drive and stores the received advertisements in the advertisement packet AD_PA for possible repeated display. The display unit 300 receives the streaming data from the memory and also the control information SC in the advertisement packet AD_PA from the network interface. Therefore, the display unit 300 switches between the streaming data and the advertisements to display according to the control information SC.

Therefore, the embodiment of the present invention has the following advantages. The central advertising control provides simple advertising process with various statistics, such as preferred levels of the advertisements and user's information, and simplifies customization as well. The formats of the advertisements are also controls by the advertise server 110 and can be easily modified according to advertisement providers. The central server, the advisement server and the users UE1-UE6 all need no re-edition for the streaming data, thereby saving system resources and processing time.

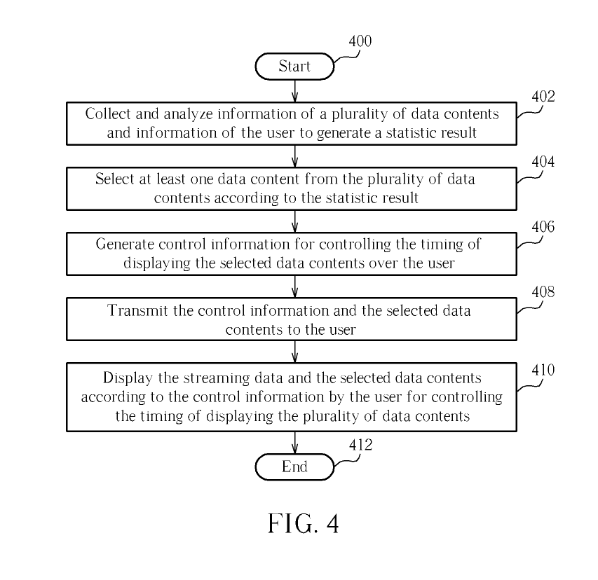

Please refer to FIG. 4, which is a flowchart of a process 40 for inserting data into streaming data according to the present invention. The process 40 is utilized to realize the framework 10 and includes the following steps:

Step 400: Start.

Step 402: Collect and analyze information of a plurality of data contents and information of the user to generate a statistic result.

Step 404: Select at least one data content from the plurality of data contents according to the statistic result.

Step 406: Generate control information for controlling the timing of displaying the selected data contents over the user.

Step 408: Transmit the control information and the selected data contents to the user.

Step 410: Display the streaming data and the selected data contents according to the control information by the user for controlling the timing of displaying the plurality of data contents.

Step 412: End.

The plurality of data contents are preferably the abovementioned advertisements or other business-oriented information. According to the process 40, the statistic result is generated according to information of the advertisements (i.e. preferred levels of the advertisements) and information of the user (i.e. attributes of an identity, an interest and an occupation). According to the statistic result, the advertising packet including the selected advertisements and the control information fits the favor of the user. After the user receives the advertising packet, the received advertisements can be displayed at the time points before, during or after the display of the streaming data. If the timing point is set during the display of the streaming data, the streaming data is temporarily stopped and the user switches to display the advertisements.

In summary, according to the embodiments of the present invention, the advertise server realizes a central advertisement control and can control the timing of displaying advertisements on the user to achieve data insertion into the on-displaying streaming. Besides, the streaming of the streaming data is not cut-off directly by the advertise server so that the streaming data can be resumed easily. Any streaming data for display does not need to be combined with advertisements beforehand. Therefore, the embodiments of the present invention can save lots of resource and cost for business purposes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A server for inserting data into a streaming data displayed by a user for a communications network, the server comprising:
a first store unit for storing a plurality of data contents;
a statistic unit coupled to the first store unit, for collecting and analyzing information of the plurality of data contents and information of the user to generate a statistic result;
a selecting unit for selecting at least one data content from the plurality of data contents according to the statistic result;
a displaying control unit for generating a control information for controlling the timing of displaying the selected data contents over the user; and
an output unit for transmitting the control information and the selected data contents to the user;
wherein the timing of displaying the plurality of data contents comprises a time point during the display of the streaming data.

2. The server of claim 1, wherein the data contents are advertisements.

3. The server of claim 1, wherein the data contents are text, image, media contents.

4. The server of claim 1, wherein the data contents are transmitted in a streaming way.

5. The server of claim 1, wherein the information of the data contents and the information of the user are collected from a gateway server coupled to the user and the server.

6. The server of claim 5, wherein the gateway server records personal information of the user and the request information of the user corresponding to the plurality of data contents.

7. The server of claim 6, wherein the personal information comprises attributes of an identity, an interest and an occupation.

8. The server of claim 1, wherein the user comprises:
a network interface for receiving the streaming data and the selected data contents and the control information;
a second store unit for storing the plurality of data contents;
a third store unit for storing the streaming data; and
a display unit for displaying the streaming data and the selected data contents according to the control information.

9. The server of claim 1, wherein the user receives the streaming data via a peer-to-peer file sharing network system.

10. The server of claim 1, wherein the timing of displaying the plurality of data contents further comprises a time point of waiting a request, a time point before the display of the streaming data, and a time point after the display of the streaming data.

11. A method of inserting data into a streaming data displayed by a user coupled to a server via a communications network, the server comprising a plurality of data contents, the method comprising:
collecting and analyzing information of the plurality of data contents and information of the user to generate a statistic result;
selecting at least one data content from the plurality of data contents according to the statistic result;
generating a control information for controlling the timing of displaying the selected data contents over the user;
transmitting the control information and the plurality of data contents to the user; and
displaying the streaming data and the selected data contents according to the control information;
wherein the timing of displaying the plurality of data contents comprises a time point during the display of the streaming data.

12. The method of claim 11, wherein the data contents are advertisements.

13. The method of claim 11, wherein the data contents are text, image, media contents.

14. The method of claim 11, wherein the data contents are transmitted in a streaming way.

15. The method of claim 11 further comprising recording personal information of the user and the request information of the user corresponding to the plurality of data contents.

16. The method of claim 15, wherein the personal information comprises attributes of an identity, an interest and an occupation.

17. The method of claim 11, wherein the streaming data is received by the user via a peer-to-peer file sharing network system.

18. The server of claim 11, wherein the timing of displaying the plurality of data contents further comprises a time point of waiting a request, a time point before the display of the streaming data, and a time point after the display of the streaming data.
